(19) United States
(12) Patent Application Publication
(10) Pub. No.: US 2009/0185360 A1
(43) Pub. Date: Jul. 23, 2009

(54) Evacuation Station with Single Lightstick Activation

(76) Inventors: William R. Palmer, Rescue, CA (US); Stephen L. Palmer, Cameron Park, CA (US)

Correspondence Address: MCHALE & SLAVIN, P.A., 2855 PGA BLVD, PALM BEACH GARDENS, FL, 33410, US

(21) Appl. No.: 12/017,577

(22) Filed: Jan. 22, 2008

(51) Int. Cl. F21K 2/00; B60Q 1/00

(52) U.S. Cl. 362/34; 362/478

(57) ABSTRACT

A chemiluminescent lightstick evacuation station consisting of a wall mountable fixture that stores a plurality of lightsticks that are accessed by opening the fixture cover. The fixture cover is opened by pivoting from a closed position to an open position wherein a lightstick restraint causes the activation of one lightstick so as to illuminate the remaining lightsticks to facilitate their removal during an emergency.

### FIELD OF THE INVENTION

This invention is directed toward the field of devices for emergency assistance and more particularly, to a housing of chemiluminescent lightsticks for use in emergency situations.

### BACKGROUND OF THE INVENTION

The ability to evacuate an area during an emergency is typically hampered by the loss of ambient lighting. For instance, evacuation from a train wreck will undoubtedly be made more difficult if no light is available. In fact, the loss of lighting will typically cause a panic situation whether the emergency is weather related, i.e. an earthquake, or simply a power grid failure. When the evacuation includes numerous people, it is a necessity to stop panic and evacuate in an orderly manner for the safety of all involved. For these reasons, the need for emergency lighting is mandatory under most building codes.

Emergency lighting typically takes the form of fixed lighting powered by an AC source with a DC back-up battery. The reliability of a fixed system is dependant upon the maintenance of the back-up battery but in any event remains a fixed system. Evacuation procedures require the individuals to leave an area, thus the effectiveness of a fixed lighting system becomes problematic. Panic stricken individuals may refuse to leave a lighted area. For instance, the evacuation during an earthquake may require individuals to leave a lighted area, the lack of lighting in the exit way may prevent an orderly and safe evacuation. The survivors of a plane crash require the individuals to leave the plane wherein the fixed light does not provide any coverage. Evacuation of a motel or apartment building is dependant upon the maintenance of multiple fixed lights along an exit route. Failure of any system along the exit route may cause confusion and panic as the individuals search for the avenue of escape. Battery powered lights are only as good as the battery. If the battery has not been properly maintained or replaced, the battery powered light will fail.

Due to the limitations of fixed lighting and battery powered systems, a well accepted alternative lighting system is the use of chemiluminescent lightsticks. Chemiluminescent lightsticks provide portable light by the use of a chemical reaction not dependent upon any electrical power or batteries.

The long storage life and the excellent quality of light produced from current chemiluminescent lightsticks has made the product a mainstay in the industry for emergencies. A “chemiluminescent composition” that is interpreted to mean a mixture or component thereof which will result in chemiluminescent light production when reacted with other necessary reactants in the processes as disclosed herein.

Chemiluminescent lighting devices are commonly used as a supplement and/or replacement for conventional illumination devices such as flashlights and flares. Chemiluminescent devices are non-incandescent products and are most valuable for emergency lighting applications such as when normal electrical power service is interrupted. Power interruptions often accompany storms, floods, hurricanes, fires, earthquakes and the like natural disasters. Additionally, because chemiluminescent devices do not rely on electricity for operation, they are readily and reliably used in wet environments, even under water, where electrically powered devices could short out and fail.

Chemiluminescent light production generally utilizes a two-component system to chemically generate light. Chemiluminescent light is produced by combining the two components, which are usually in the form of chemical solutions referred to as the “oxalate” component and the “activator” component. The two components are kept physically separated by a sealed, frangible, glass vial containing one component is housed within an outer flexible container containing the other component. Typically, this outer container is sealed to contain both the second component and the filled, frangible vial. Forces created by intimate contact with the internal vial, e.g. by flexing, cause the vial to rupture, thereby releasing the first component, allowing the first and second components to mix and produce light. Since the objective of this type of device is to produce usable light output, the outer vessel is usually composed of a clear or translucent material, such as polyethylene or polypropylene, which permits the light produced by the chemiluminescent system to be transmitted through the vessel walls.

These devices may be designed so as to transmit a variety of colors by either the addition of a dye or fluorescent compound to one or both of the chemiluminescent reactant compositions or to the vessel. Furthermore, the device may be modified so as to only transmit light from particularly chosen portions thereof.

Examples of such a chemiluminescent system include: U.S. Pat. No. 5,043,851 issued to Kaplan. Kaplan discloses a polygonal, chemiluminescent lighting device which concentrates light in the corners of the device, thus enhancing visibility of light emanating from the light stick portion of the device and optimizing the amount and distribution of light radiated.

U.S. Pat. No. 4,626,383 to Richter et al. discloses chemiluminescent catalysts in a method for producing light in short duration, high intensity systems, and low temperature systems. This invention relates to catalysts for two component chemiluminescent systems wherein one component is a hydrogen peroxide component and the other component is an oxalate ester-fluorescent component.

U.S. Pat. No. 4,186,426 discloses a chemiluminescent lightstick with an attached actuating device stored inside a container having a hinged lid which opens for access to and for display of the lightstick. The container includes a clamping means by which the lightstick is held at a display position holding the lid of the container open. In this mode, the lightstick and container make a convenient lantern.

U.S. Pat. No. 6,336,729 discloses a lighting system including a chemiluminescent stick supported within a holder. A break bar pivotally connected to the cover is initially in a vertical orientation, and temporarily retained by a latch to allow insertion of the lightstick in the holder and closure of the cover. When the cover is closed, the latch is released, which allows the break bar to move behind the lightstick, in a horizontal orientation. When the cover is then opened, the break bar engages the lightstick, and bends the lightstick forward around an edge to illuminate the lightstick.

U.S. Pat. No. 6,033,080 discloses an emergency light device including a chemiluminescent lightstick which can be easily removed. When an operating lever is pushed, an engaging portion of a pivoting member pushes the bottom portion of the chemiluminescent lightstick toward a wall surface. The chemiluminescent Nightstick has on the top end thereof a head secured to a hook of a holding member. The chemiluminescent light stick can be easily bent to illuminate by the lever principle with the protuberance of a case body serving as a fulcrum and the engaging portion serving as the point of action. When the operating lever is further pushed, the top end of the pivoting member protrudes frontward to open a top cover and the holding member which has been restricted by the pivoting member is released and it moves upward by the urging force of a flat spring and the pressing force applied by the head of the chemiluminescent lightstick, thus enabling the chemiluminescent lightstick to be removed.

U.S. Pat. No. 5,446,629 discloses a mounted emergency light fixture. The light fixture has a mount assembly and a front cover with a break plate which bends a lightstick inserted into the fixture when the cover is pivoted from a closed to an open position. The mount assembly has a restraining plate and a back side which maintain the lightstick within the mount when the cover is pivoted to the open position. Hence, after the cover is opened the lightsticks are illuminated and are held in the mount or may be removed to provide emergency lighting.

U.S. Pat. No. 6,065,847 discloses a chemiluminescent lighting device that may include a holder. The holder permits the user to activate the lightstick upon removal from the holder.

The above mentioned prior art all recognize the need for quick access to a lightstick to address emergency situations and the need to have the lightstick readily available. Additionally, in emergency situations, a person attempting to activate the light stick may not have full manual capacity or mental capacity for reasons attributed to the cause of the emergency. The present invention mitigates these problems. What is lacking in the art is a storage container for chemiluminescent lightsticks, the storage container including a means for automatically latching the storage device and activating one of the lightsticks producing light for illumination of the container and remaining lightsticks.

### SUMMARY OF THE INVENTION

The emergency light fixture of the present invention consists of a mounting plate having a lightstick receptacle secured thereto. The receptacle includes a plurality of sockets available for receipt of lightsticks. A flexible latching seat is secured to the mounting plate and adapted to receive one end of a lightstick. A front cover is hingedly attached to the mounting plate and includes a latching bracket for securing a lightstick in a fixed position parallel to the front cover. The front cover is pivotally attached to the mounting plate to facilitate the movement of the front cover with respect to the mounting plate from a closed position to an open position. When the front cover is rotated to an open position, chemiluminescent lightsticks may be placed within the lightstick sockets for storage, the sockets allowing ease of removal. One lightstick is then placed into the latching bracket on the cover, upon closure of the front cover the end of the latching lightstick engages the flexible latching seat thereby securing the front cover in a closed position. Opening of the front cover causes the lightstick held in the latching mechanism to flex resulting in illumination of the lightstick thereby providing illumination of the remaining stored lightsticks.

The mounting plate may be mounted on any convenient, substantially planar surface such as a wall or the like, preferably at a previously selected, accessible location. For instance, the mounting plate may be placed near the exit door on a train, plane, boat or cruise ship, motel, apartment hallway, school hallway, locker room, factory exit lane, and so forth. The proper placement is where a potential user of the device will be able to find the light source in an emergency because the fixture is easily accessible and because the light is permanently mounted at a predetermined, consistent location. Also unique to chemiluminescent devices are their ability to produce light without generating heat. Since chemiluminescent devices are not electrically operated or sources of ignition, they are ideally suited to emergency situations such as the aforementioned disasters. For instance, in situations where flammable vapors such as gasoline or natural gas may be present, conventional illumination such as candles, lanterns or even flashlights pose extreme danger as potential sources of ignition.

In operation, a light stick is positioned in the fixture and is retained in position by the latching bracket on the front cover while the device is in a closed position. Then, when the cover of the fixture is pivoted to the open position, the latching bracket causes rotation of the lightstick while the latch mechanism on the mounting plate resists movement, resulting in the bending/activation of the lightstick. The activated lightstick provides an upward facing light with the front cover providing a reflector base. The result is a light that illuminates the remaining unlit lightsticks, the wall supporting the mounting plate further operates as reflecting surface so as to highlight an escape route.

Thus, when the cover is pivoted to a sufficient angular extent with respect to the plane of the back side of the mount assembly, the light stick will bend sufficiently to break the ampoules within the lightstick and then, as the cover is further pivoted, the remaining lightsticks are made available for ease of removal from the mounting plate.

Accordingly, the cover is allowed to move to a fully open position, with the illuminated light stick remaining in the front cover to provide light the upward facing light to the surroundings and inactivated lightsticks. The activation procedure is easily performed; it is simply a matter of pulling down the cover.

An objective of the instant invention is to provide an evacuation station capable of being mounted on any surface and providing activation of at least one chemiluminescent lightstick for illumination of the remaining stored lightsticks.

Another objective of the instant invention is to provide an evacuation station having a lightstick that operates as the latching mechanism so as to provide automatic arming by placement of a lightstick into a latching bracket.

Still another objective of the instant invention is to provide an evacuation station having placement of an illuminated lightstick in a horizontal plane so as to provide upward illumination of the light for purposes of illuminating the remaining lightsticks as well as the mounting wall; so as to provide evacuees with the point of reference without having the light directly in their eyes that may otherwise cause disorientation.

Still another objective of the instant invention is to provide an evacuation station having an enclosure so as to prevent ambient light during storage to prolong the useful life of the chemiluminescent chemicals.

Still another objective of the instant invention is to provide evacuation station for use with chemiluminescent lights that include security seal tag to indicate that the contents have not been disturbed by vandals.

Yet another objective of the instant invention is to provide an evacuation station having a front panel with an integrated handle for ease of opening by use of a leveraged opening allowing ease of activating the lightstick held in the latching bracket.

Yet still another objective of the instant invention is to provide an evacuation station having a front cover of substantial height and width that allows for placement of indicating indicia providing evacuees with instructions in operation and usage.

Yet still another objective of the instant invention is to provide a tilt out socket holder that allows ease of access of the stored lightsticks when the front cover is placed in an open position.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objectives and features thereof.

### BRIEF DESCRIPTION OF THE FIGURES

FIG. 1 is a perspective view of the storage container;

FIG. 2a is a cross sectional side view of the storage container illustrating the automatic loading of a chemical lightstick;

FIG. 2b is a cross sectional side view of the storage container illustrating a chemical lightstick locked into position for activation;

FIG. 2c is a cross sectional side view of the storage container illustrating the opening of the container causing activation of a chemical lightstick;

FIG. 3 is a perspective view of the chemical lightstick housing with the lightsticks available for removal.

### DETAILED DESCRIPTION OF THE INVENTION

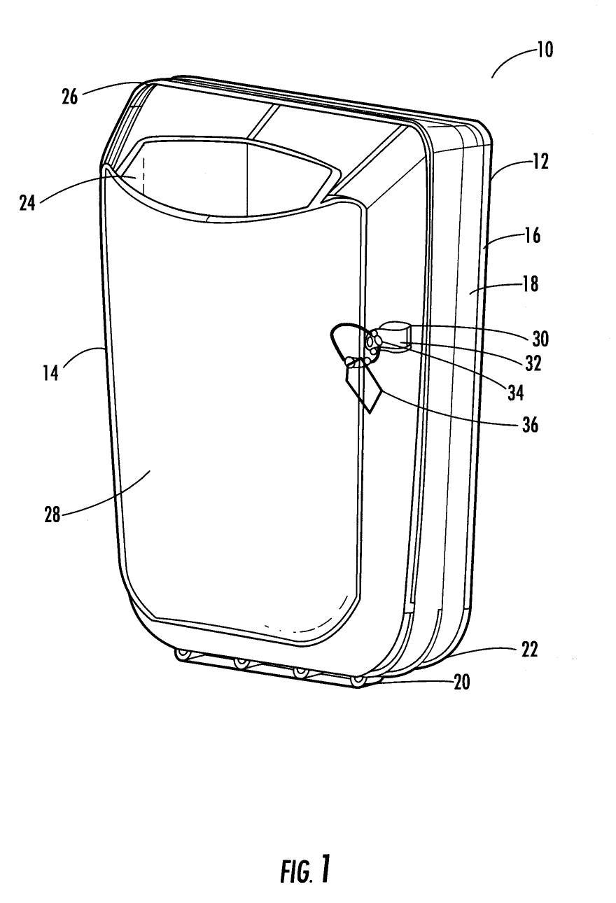

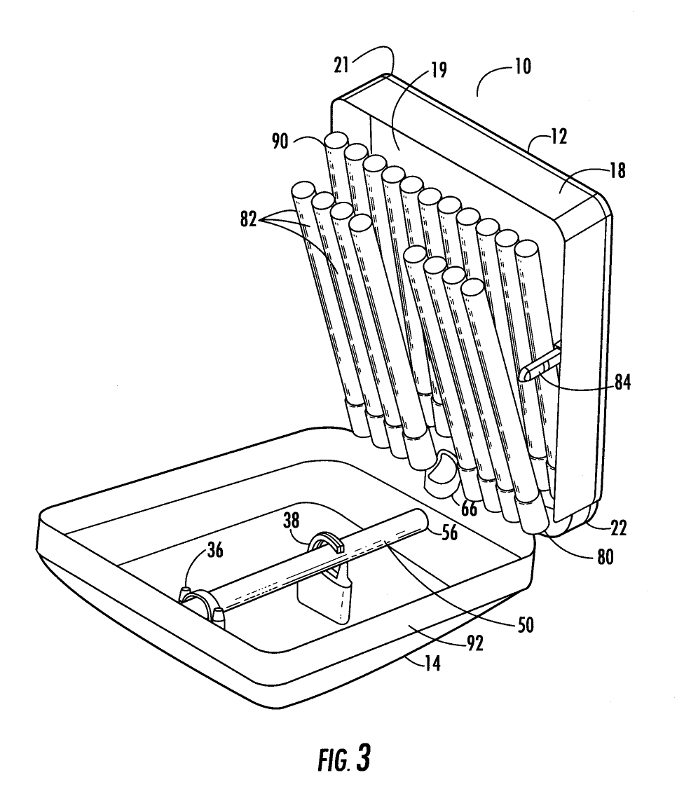

Referring now to FIG. 1, set forth is an emergency light fixture (10) consisting of a mounting plate (12) available for securement to a mounting surface such as a wall, vertical support beam, door or the like upright surface. Attachment of the mounting plate to a vertical surface is by adhesive, double-sided tape, glue, screws, nails or the like fasteners. A front surface (19) of the mounting plate is exposed when the front cover (14) is placed in an open position allowing concealment of mounting fasteners. The mounting plate has a peripheral edge (16) extending around the outer edge formed by the mounting plate with an outward extending wall (18). The front cover (14) is attached by a hinge (20) located along the bottom of the sidewall and is operatively associated with the mounting plate sidewall located on along the bottom (22). The front cover (14) includes a hand hold (24) that allows for placement of an individuals fingers for ease of pulling the cover from a closed position, as shown, to an open position (shown in FIG. 3) with the hand hold (24) placed along an upper edge (26) of the front cover providing optimal leverage when used in conjunction with the lower mounted pivot hinge (20).

The front cover has an outer surface (28) having a width and height for placement of indicia either molded in, or by use of a fluorescent or photoluminescent decal which would allow the evacuation station to glow when there is a lack of natural light. The decal may exhibit instructions such as an arrow indicating the user to pull down on the cover so as to activate the emergency light fixture. The front cover (14) further includes an aperture (30) that allows passage of a tab (32) formed integral or secured to the mounting plate (12). The tab (32) includes an aperture (34) allowing placement of a tamper indicator tag (36) which provides evidence that the evacuation station has not been tampered with since the loading of the lightsticks. This will assure that the chemicals have not been exposed to light thereby providing extended life with the knowledge that all lightsticks placed within the evacuation station are ready should there by an evacuation procedure.

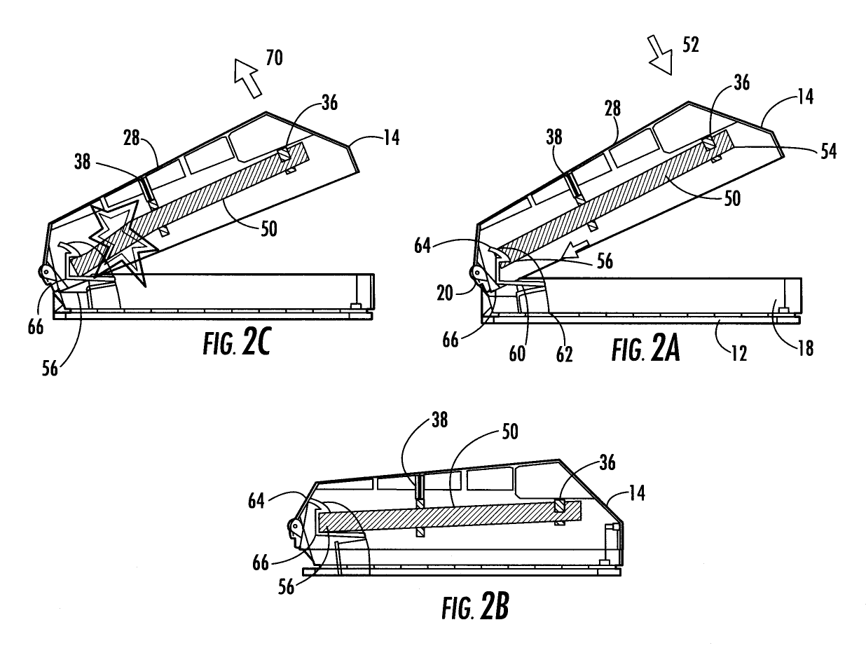

Referring now to FIGS. 2a-2c, FIG. 2a depicts the mounting plate (12) the sidewall (18) coupled to front cover (14) across hinge (20). Within the front cover (14) is located a latching bracket consisting of an upper bracket (36) and a middle bracket (38). The brackets may consist of wire ties, or molded in circular shaped or hook shaped with the purpose of maintaining a lightstick (50) in a position substantially parallel to the surface (28) of the front cover (14). FIG. 2a depicts the lightstick (50) placed within the latching bracket consisting of a holder (36 and 38) with a front cover (14) being placed into a closed position as indicated by arrow (52). For illustration the lightstick (50) is further depicted by an upper end (54) and lower end (56). The mounting plate (12) includes a flexible latching seat (66). The flexible latching seat (66) has a first end (62) which is secured to the mounting plate (12) and a distal end (64) that allows for flexation of the latching seat while the lightstick is being placed into the latching brackets during closure.

In operation, the lightstick (50) is placed within the front cover and is maintained by the latching bracket having securement (36 and 38) so as to maintain the lightstick in a fixed and parallel position relative to the front cover. When the front cover is being placed into a closed position the Nightstick end (56) pushes against the lightstick receptacle flexible distal end (64) which is preferably rounded so as to allow for ease of entry of lightstick end (56) into the latching seat (66). Distal end (64) of flexible latching seat (66) will be resiliently deflected by light stick end (56) (as shown by arrow A) as the cover is moved from an open to closed position. When the cover is completely closed the distal end will return to its original position and the light stick So will be securely situated in the flexible latching seat (66). As depicted in FIG. 2b the flexible latching seat (66) is now in receipt of the lightstick end (56) with the distal end (64) of the flexible latching seat (66) impacting the inner sidewall of the front cover (14) so as to provide assurance that the lightstick is in the proper position and armed for usage.

Now referring to FIG. 2c depicted is the front cover (14) being placed into an open position as depicted by arrow (70) wherein the lightstick (50) is maintained in a parallel position with the outer surface (28) of the front cover by use of latching brackets (36 and 38). The opening of the front cover results in the bending of the lightstick due to placement of the end of the lightstick (56) placed within the latching seat (66). The result is a cracking of the frangible ampoule within the lightstick resulting in the mixture of the chemiluminescent chemicals for purposes of illumination.

Referring now to FIG. 3 shown is an open view of emergency light fixture (10) having mounting plate (12) with the outwardly extending sidewall (18) extending around the peripheral edge of the mounting plate. The mounting plate is further defined as a front side (19) and a backside (21). The front side allows for concealment of fasteners and further operates as an inner wall so as to inhibit ambient light from reaching the lightsticks during a storage period. The backside (21) is available for securement to the wall again with most any type of fastener depending upon the type of installation warranted. For instance, the use of conventional screw or nail fasteners onto a metal post is impractical wherein adhesive or two way tape is more practical. In addition, placement of fasteners on the skins of vehicles such as airplanes or trains is also impractical wherein a flat backside allows for various types of adhesives for attachment. In instances where the evacuation station is placed against wall paper it would be more feasible to use conventional fasteners such as dry wall fasteners or screws so as to provide securement into otherwise weak surfaces.

The mounting plate (12) includes a plurality of sockets (80) for storage of the lightsticks (82). Depicted is a holder of twenty lightsticks, one of which is activated and the remaining held in storage. It should be noted that this evacuation station may hold as few as two lightsticks and upwards of one hundred, with a limitation only due to the size of the housing. For instance, the need for a large number of lightsticks would be practical for cruise ships. The lightstick receptacle (80) is preferably hingedly attached to the mounting plate along the lower end (22) with a bracket (84) so as to allow the tilting of the lightsticks away from the front side (19) of the mounting plate when the front cover is placed in an open position. FIG. 3 illustrates the lightsticks tilted forward which allows for ease of access of the lightsticks including those lightsticks found along the back row (90).

The lightstick (50) that is automatically activated is shown in the unarmed position with securement bracket (36 and 39) maintaining the lightstick (50) in a fixed position. The lower end (56) of the lightstick is available for placement into the flexible latching seat (66) upon closure of the front cover (14). The front cover including an inwardly extending sidewall (92) which is operatively associated with the outwardly extending sidewall (18) of the mounting plate (12). While in the closed position the sidewalls inhibit ambient light from reaching the lightsticks (82) thereby allowing the use of unshielded lightsticks providing ease of activation without the use of a conventional covering found in the sale of individual lightsticks.

One of the benefits of chemiluminescent lighting devices is the ability to provide light upon demand. However, the chemicals that cause the chemiluminescent reaction must be properly protected to prevent premature chemical degradation. Chemiluminescent chemicals are subject to degradation but, if shielded from light, optimum illumination can be expected if properly stored. For this reason, such devices are typically packaged in aluminum foil. To activate a conventional chemiluminescent device, an individual must tear open the foil package, remove the packaging from the device, and then activate the device to cause the chemical reaction and subsequent illumination. In instances of an evacuation, the time needed to open individual packages may not be available. Thus, the use of the enclosed fixtures with cooperating sidewalls allows the storage of unpackaged lightsticks that have a long life as they remain protected from light while secured in the fixture.

Examples of suitable light stick products for use herein are the light sticks sold by Cyalume Technologies LLC under the trademarks “Cyalume” and “Snaplight”. Further details concerning the construction and operation of chemiluminescent lighting devices may be found in U.S. Pat. Nos. 3,539,794; 3,576,987; 4,508,642; 4,193,109; 4,814,949 and 5,043,851; the subject matter of which patents are incorporated herein by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and drawings/figures. One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An emergency light fixture comprising:
a mounting plate having a front side and a back side with a peripheral edge, and an outwardly extending side wall formed integral with said peripheral edge;
a lightstick receptacle secured to said mounting plate, said receptacle having a plurality of sockets available for receipt of lightsticks;
a flexible latching seat secured to said mounting plate and adapted to receive one end of a latching lightstick;
a front cover hingedly attached to said mounting plate, said front cover having an inwardly extending side wall operatively associated with said outward extending side wall and a latching bracket for securing said latching Nightstick in a fixed position parallel to said front cover;
wherein opening of said front cover due to an emergency event causes the lightstick held in the front cover to flex resulting in illumination thereof and ease of access to the remaining unactivated lightsticks.

2. The fixture of claim 1 including a fastening means for securing said mount assembly to a fixed surface.

3. The fixture of claim 1 wherein said Nightstick receptacle pivots outwardly for ease of accessing said lightsticks when said front cover is placed in an open position.

4. The fixture of claim 1 wherein a hand hold is formed in said cover for ease of pulling the cover from a closed position to an open position.

5. The fixture of claim 1 said side walls cooperated to prevent exposure of the light sticks to ambient light when said front cover is in a closed position.

6. The fixture of claim 1 wherein said front panel has an outer surface and is shaped to receive a decal with instructions indicating how to activate said fixture and an element which glows in dark surroundings to signal the location of the fixture.

7. The fixture of claim 1 wherein said lightstick is of a distinct wavelength or color.

8. The fixture of claim 1 including a locking tab extending from said mounting plate through said front cover for attachment of a tamper indicating tag.

9. An emergency light fixture that is armed upon closing of a front cover comprising:
a mounting plate having a front side and a back side with a peripheral edge, and an outwardly extending side wall formed integral with said peripheral edge;
a lightstick receptacle secured to said mounting plate, said receptacle having a plurality of sockets available for receipt of lightsticks;
a flexible latching seat secured to said mounting plate and adapted to receive one end of a latching lightstick;
a front cover hingedly attached to said mounting plate, said front cover having an inwardly extending side wall operatively associated with said outward extending side wall and a latching bracket for securing said latching lightstick in a fixed position parallel to said front cover;
wherein said front cover is rotated to an open position allowing placement of chemiluminescent lightsticks within said lightstick sockets and one lightstick within said latching bracket, closure of said front cover causes the end of the latching lightstick to engage said flexible latching seat thereby securing said front cover in a closed position whereby opening of said front cover due to an emergency event causes the lightstick held in the latching lightstick to flex resulting in illumination of the latching lightstick for illumination of all the stored lightsticks.

10. The fixture of claim 9 including a fastening means for securing said mount assembly to a fixed surface.

11. The fixture of claim 9 wherein said lightstick receptacle pivots outwardly for ease of accessing said lightsticks when said front cover is placed in an open position.

12. The fixture of claim 9 wherein a hand hold is formed in said cover for ease of pulling the cover from a closed position to an open position.

13. The fixture of claim 9 said side walls cooperated to prevent exposure of the light sticks to ambient light when said front cover is in a closed position.

14. The fixture of claim 9 wherein said front panel has an outer surface and is shaped to receive a decal with instructions indicating how to activate said fixture and an element which glows in dark surroundings to signal the location of the fixture.

15. The fixture of claim 9 wherein said Nightstick is of a distinct wavelength or color.

16. The fixture of claim 9 including a locking tab extending from said mounting plate through said front cover for attachment of a tamper indicating tag.

17. The fixture of claim 9 wherein said latching seat include a sloped frontal edge to facilitate arming of the light fixture by closing of the front cover.

18. The fixture of claim 9 wherein said latching seat include a sloped frontal edge to facilitate arming of the light fixture by closing of the front cover.
